(19) United States
(12) Patent Application Publication
(10) Pub. No.: US 2006/0015317 A1
(43) Pub. Date: Jan. 19, 2006

(54) Morphological analyzer and analysis method

(75) Inventor: Tetsuji Nakagawa, Osaka (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/179,619

(22) Filed: Jul. 13, 2005

(30) Foreign Application Priority Data
Jul. 14, 2004 (JP) 2004-206996

(51) Int. Cl. G06F 17/20

(52) U.S. Cl. 704/1

(57) ABSTRACT

A morphological analyzer divides a received text into known words and unknown words, divides the unknown words into their constituent characters, analyzes known words on a word-by-word basis, and analyzes unknown words on a character-by-character basis to select a hypothesis as to the morphological structure of the received text. Although unknown words are divided into their constituent characters for analytic purposes, they are reassembled into words in the final result, in which any unknown words are preferably tagged as being unknown. This method of analysis can process arbitrary unknown words without requiring extensive computation, and with no loss of accuracy in the processing of known words.

### BACKGROUND OF THE INVENTION

1. Field of the Invention

The present invention relates to a morphological analyzer and a method of morphological analysis, more particularly to a method and analyzer that can accurately analyze text including unknown words.

2. Description of the Related Art

A morphological analyzer divides an input text into words (morphemes) and infers their parts of speech. To be able to conduct a robust and accurate analysis of a variety of texts, the morphological analyzer must be able to analyze words not stored in its dictionary (unknown words) correctly.

Japanese Patent Application Publication No. 7-271792 describes a method of Japanese morphological analysis that uses statistical techniques to deal with input text including unknown words. From a part-of-speech tagged corpus, a word model and a part-of-speech tagging model are prepared: the word model gives the probability of occurrence of an unknown word given its part of speech, based on character trigram statistics; the part-of-speech tagging model gives the probability of occurrence of a word given its part of speech, and the probability of occurrence of a part of speech given the previous two parts of speech. These models are then used to identify the most likely word boundaries (not explicitly indicated in Japanese text) in an arbitrary sentence, assign the most likely part of speech to each word, output a most likely hypothesis as to the morphology of the sentence, and then generate a selectable number of additional hypotheses in decreasing order of likelihood. The character trigram information is particularly useful in identifying unknown words, not appearing in the corpus, and their parts of speech.

One problem with this method is that character trigram probabilities do not provide a reliable basis for identifying the boundaries and parts of speech of unknown words. Accordingly, because the method generates only a limited number of hypotheses, it may fail to generate even one hypothesis that correctly identifies an unknown word, and present misleading analysis results that give no clue as to the word's correct identity. If the number of hypotheses is increased to reduce the likelihood of this type of failure, the amount of computation necessary to generate and process the hypotheses also increases, and the analysis process becomes slow and difficult to make use of in practice.

Other known methods of dealing with unknown words generate hypotheses for words that tend to occur in personal names, or generate hypotheses for unknown words by using rules or probability models relating to special types of characters appearing in the words (numeric characters, or Japanese katakana characters, for example), but the applicability of these methods is limited to special categories of words; they fail to address the majority of unknown words.

A more general known method separates all words into their constituent characters, and performs the morphological analysis on the characters by tagging each character with a special tag indicating the word-internal position of the character. This method can analyze arbitrary unknown words, but it involves a considerable sacrifice of accuracy, because it does not make full use of information about known words and groupings of known words.

It would be desirable to have a morphological analysis method and program and a morphological analyzer that could analyze text including arbitrary unknown words without taking undue time, sacrificing accuracy, or producing misleading results.

### SUMMARY OF THE INVENTION

An object of the present invention is to provide an accurate method of performing a morphological analysis on text including unknown words.

Another object of the invention is to provide a robust method of performing a morphological analysis on text including unknown words.

The invention provides a morphological analysis method in which one or more hypotheses are generated as candidate results of a morphological analysis of a received text. The hypotheses include a hypothesis in which known words listed in a dictionary are presented together with the individual characters constituting an unknown word. The probability of occurrence of each of the one or more hypotheses is calculated by using a stochastic model that takes account of morphemes, groups of consecutive morphemes, and characters constituting words, and a solution is selected from among the one or more hypotheses according to the calculated probabilities. If the solution includes characters constituting an unknown word, these characters are reassembled to restore the unknown word.

The invented method is accurate because it makes full use of available information about known words and groups of known words.

The invented method is robust in that, by dividing unknown words into their constituent characters, it can analyze any unknown word on the basis of linguistic model information about the characters.

### BRIEF DESCRIPTION OF THE DRAWINGS

In the attached drawings:

FIG. 1 is a functional block diagram of a morphological analyzer according to a first embodiment of the invention;

FIG. 2 is a flowchart illustrating the operation of the first embodiment during morphological analysis;

FIG. 3 is a flowchart illustrating the hypothesis generation operation in more detail;

FIG. 4 shows an example of information stored in a dictionary;

FIG. 5 shows an example of hypotheses generated in the first embodiment;

FIG. 6 is a functional block diagram of a morphological analyzer according to a second embodiment of the invention;

FIG. 7 is a flowchart illustrating the operation of the second embodiment during morphological analysis; and

FIG. 8 is a flowchart illustrating the parameter calculation operation in more detail.

### DETAILED DESCRIPTION OF THE INVENTION

Embodiments of the invention will now be described with reference to the attached drawings, in which like elements are indicated by like reference characters.

### FIRST EMBODIMENT

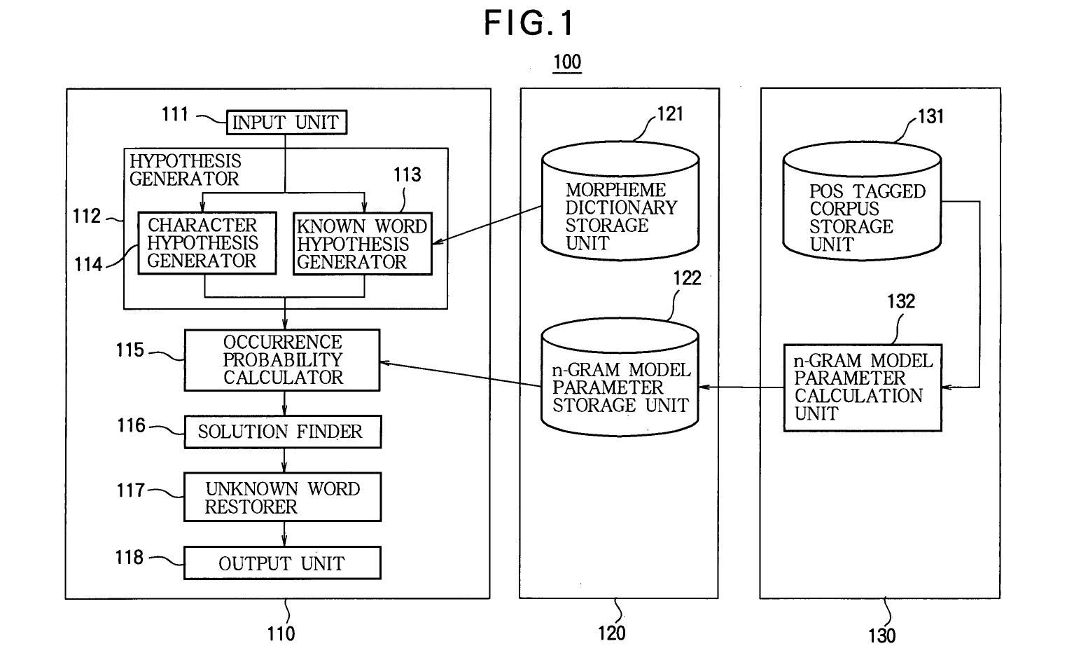

The first embodiment is a morphological analyzer that may be realized by, for example, installing a set of morphological analysis programs in an information processing device such as a personal computer. The programs may be installed from a storage medium, entered from a keyboard, or downloaded from another information processing device or network. Functionally, the morphological analyzer has the structure shown in FIG. 1. The morphological analyzer may also be implemented by specialized hardware, comprising, for example, one or more application-specific integrated circuits (ASICs) for each functional block in FIG. 1.

The morphological analyzer 100 in the first embodiment comprises an analyzer 110 that performs morphological analysis, a model storage facility 120 that stores a dictionary and parameters of an n-gram model used in the morphological analysis, and a model training facility 130 that trains the model from a part-of-speech-tagged corpus of text provided for parameter training. An n-gram is a group of n consecutive morphemes, where n is an arbitrary positive integer. A morpheme is typically a word, symbol, or punctuation mark.

The analyzer 110 comprises an input unit 111, a hypothesis generator 112, an occurrence probability calculator 115, a solution finder 116, an unknown word restorer 117, and an output unit 118.

The input unit 111 enables the user to enter the source text on which morphological analysis is to be performed. The input unit 111 may be, for example, a manual input unit such as a keyboard, an access device that reads the source text from a recording medium, or an interface that receives the source text by communication from another information processing device.

Given a sentence or other input text to be analyzed, the hypothesis generator 112 generates candidate solutions (hypotheses) to the morphological analysis. The hypothesis generator 112 has a known word hypothesis generator 113 that uses a morpheme dictionary stored in a morpheme dictionary storage unit 121, described below, to generate hypotheses comprising known words in the input source text, and a character hypothesis generator 114 that generates hypotheses by treating each character in the source text as a character in an unknown word. The full set of hypotheses generated by the hypothesis generator normally includes hypotheses that are generated partly by the known word hypothesis generator 113 and partly by the character hypothesis generator 114.

The occurrence probability calculator 115 calculates probabilities of occurrence of the hypotheses generated by the hypothesis generator 112 by using parameters stored in an n-gram model parameter storage unit 122, described below.

The solution finder 116 selects the hypothesis with the maximum calculated probability as the solution to the morphological analysis.

If the solution selected by the solution finder 116 includes characters constituting an unknown word, the unknown word restorer 117 reassembles these characters to restore the unknown word. When the solution selected by the solution finder 116 does not include characters constituting an unknown word, the unknown word restorer 117 does not operate.

The output unit 118 outputs the optimal result of the analysis (the solution) to the user. The solution may include unknown words restored by the unknown word restorer 117. The output unit 118 may display the solution, print the solution, transfer the solution to another device, or store the solution on a recording medium. The output unit 118 may output a single solution or a plurality of solutions.

The model storage facility 120 comprises the morpheme dictionary storage unit 121 and the n-gram model parameter storage unit 122. In terms of hardware, the model storage facility 120 may be a large-capacity internal storage device such as a hard disk in a personal computer, or a large-capacity external storage device. The morpheme dictionary storage unit 121 and n-gram model parameter storage unit 122 may be stored in the same large-capacity storage device or in separate large-capacity storage devices.

The morpheme dictionary storage unit 121 stores a morpheme dictionary used by the hypothesis generator 112 for generating hypotheses. The morpheme dictionary may be an ordinary morpheme dictionary.

The n-gram model parameter storage unit 122 stores the parameters of an n-gram model used by the occurrence probability calculator 115. These parameters are calculated by an n-gram model parameter calculation unit 132, described below. The parameters include both parameters relating to characters constituting an unknown word and parameters relating to known words.

The model training facility 130 comprises a part-of-speech (POS) tagged corpus storage unit 131 and the n-gram model parameter calculation unit 132.

In terms of hardware, the part-of-speech tagged corpus storage unit 131 may be a large-capacity internal storage device such as a hard disk in a personal computer, or a large-capacity external storage device storing the part-of-speech tagged corpus.

The model training facility 130 uses the corpus stored in the part-of-speech tagged corpus storage unit 131 to estimate the parameters of the n-gram model, including parameters related to known words and parameters related to characters constituting unknown words. The estimated n-gram model parameters are stored in the n-gram model parameter storage unit 122.

The model training facility 130 may be disposed in a different information-processing device from the analyzer 110 and model storage facility 120, in which case the n-gram model parameters obtained by the n-gram model parameter calculation unit 132 may be transferred to the n-gram model parameter storage unit 122 through, for example, a removable and portable storage medium. If necessary, this method of transfer may also be used when the model training facility 130 and model storage facility 120 are disposed in the same information-processing device.

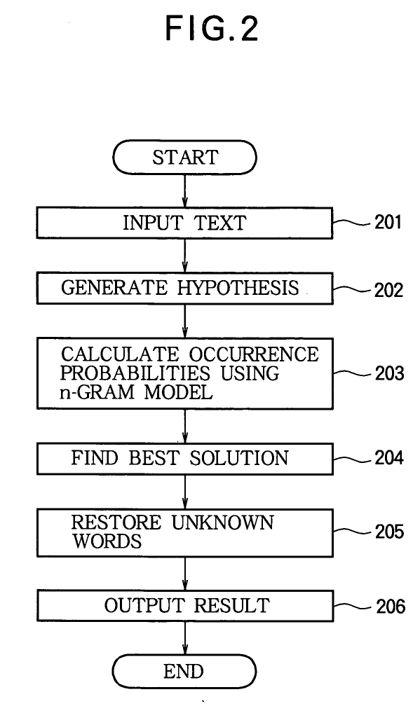

Next, the morphemic analysis method in the first embodiment will be described by describing the general operation of the morphemic analyzer 100 with reference to the flowchart in FIG. 2, which indicates the procedure by which the morphemic analyzer 100 performs morphemic analysis on an input text and outputs a result.

First, the input unit 111 receives the source text, input by a user, on which morphemic analysis is to be performed (step 201). The hypothesis generator 112 generates hypotheses as candidate solutions to the analysis of the input source text by using the morpheme dictionary stored in the morpheme dictionary storage unit 121 (step 202).

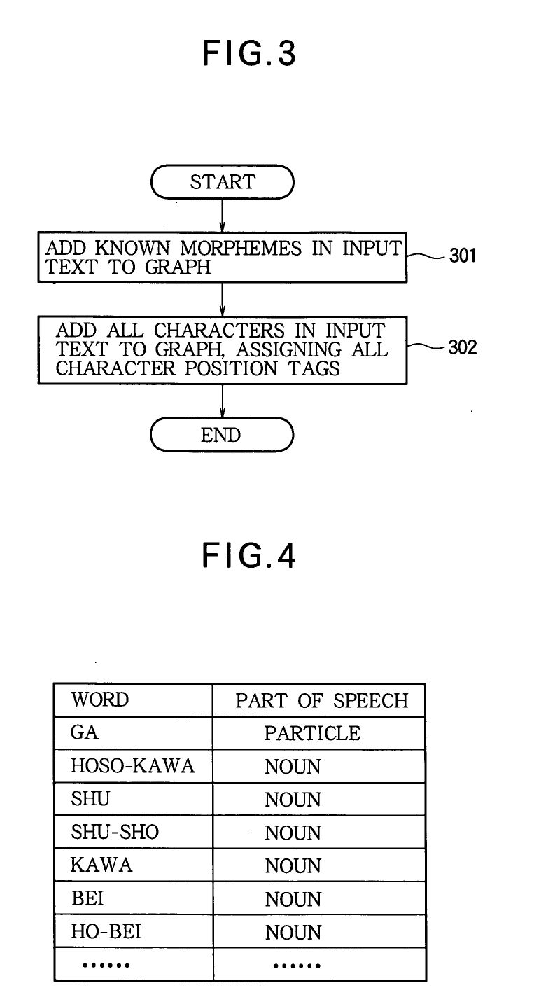

These hypotheses can be expressed by a graph having a node representing the start of the text and another node representing the end of the text; each hypothesis corresponds to a path from the starting node to the end node. The hypothesis generator 112 executes the operations illustrated in the flowchart in FIG. 3. The known word hypothesis generator 113 uses the morpheme dictionary stored in the morpheme dictionary storage unit 121 to generate nodes corresponding to known words (morphemes appearing in the morpheme dictionary) in the text input through the input unit 111, and adds these nodes to the graph (step 301). The character hypothesis generator 114 generates nodes corresponding to the individual characters constituting an unknown word, attaching character position tags indicating the position of each character in the word (step 302). The character hypothesis generator 114 uses, for example, four character position tags: a tag (here denoted B) that indicates the first character in an (unknown) word; a tag (denoted I) that indicates an intermediate character in the word (neither the first nor the last character); a tag (denoted E) that indicates the last character in the word; and a tag (denoted S) that indicates the single character in a one-character word. In a language such as Japanese in which word boundaries are unmarked, the character hypothesis generator 114 treats every word as potentially unknown, and simply generate four nodes, tagged B, I, E, and S, respectively, for each character of the input text.

Returning to FIG. 2, the occurrence probability calculator 115 uses an n-gram model with the parameters stored in the n-gram model parameter storage unit 122 to calculate probabilities for each path (hypothesis) in the graph generated in the hypothesis generator 112 (step 203).

In the following discussion, the input text has n elements, where n is an arbitrary positive integer, not necessarily the same as the ‘n’ in the n-gram model. Each element is either a known word or a character in an unknown word. The i-th element will be denoted ‘wᵢ’ and its part-of-speech tag (if it is a known word) or character position tag (if it is a character in an unknown word) will be denoted ‘tᵢ’. The notation ‘wᵢ’ (i<1) and ‘tᵢ’ (i<1) may be used to denote an element and tag at the beginning of the text, and its tag. The notation ‘wᵢ’ (i>n) and ‘tᵢ’ (i>n) may be used to denote an element and tag at the end of the text. Hypotheses, that is, tagged element sequences constituting candidate solutions to the morphological analysis, are expressed as follows.
w₁t₁ . . . wₙtₙ
Since the hypothesis with the highest probability should be selected as the solution, the best tagged element sequence satisfying equation (1) below must be found.

$$\begin{matrix}{\hat{w}}_{1} {\hat{t}}_{1} … {\hat{w}}_{n} {\hat{t}}_{n} = {arg max}_{{w}_{1} {t}_{1} … {w}_{n} {t}_{n}} P ( {w}_{1} {t}_{1} … {w}_{n} {t}_{n} ) \\ = {arg max}_{{w}_{1} {t}_{1} … {w}_{n} {t}_{n}} {\prod }_{i = 1}^{n + 1} P ( {w}_{i} {t}_{i} \vert {w}_{1} {t}_{1} … {w}_{i - 1} {t}_{i - 1} ) \\ \approx {arg max}_{{w}_{1} {t}_{1} … {w}_{n} {t}_{n}} {\prod }_{i = 1}^{n + 1} {\sum }_{M ∈ M} \{ {λ}_{1} P ( {w}_{i} {t}_{i} \vert {w}_{1} {t}_{1} ) P ( {t}_{i} ) + \\ {λ}_{2} P ( {w}_{i} \vert {t}_{i} ) P ( {t}_{i} \vert {t}_{i - 1} ) + \\ {λ}_{3} P ( {w}_{i} \vert {t}_{i} ) P ( {t}_{i} \vert {t}_{i - 2} {t}_{i - 1} ) + \\ {λ}_{4} P ( {w}_{i} {t}_{i} \vert {w}_{i - 1} {t}_{i - 1} ) \} \\ ( {λ}_{1} + {λ}_{2} + {λ}_{3} + {λ}_{4} = 1 ) .\end{matrix} \qquad ( 1 )$$

In equation (1), the best tagged element sequence is denoted ‘ˆw₁ˆt₁ . . . ˆwₙˆtₙ’ in the first line, and argmax indicates the selection of the tagged element sequence with the highest probability of occurrence P(w₁t₁ . . . wₙ₋₁tₙ₋₁) among the plurality of tagged element sequences (hypotheses).

The probability P(w₁t₁. . . wₙtₙ) of occurrence of a tagged element sequence can be expressed as a product of the conditional probabilities P(wᵢtᵢ|w₁t₁ . . . wᵢ₋₁tᵢ₋₁) of occurrence of the tagged element in the i-th position in the sequence, given the existence of the preceding tagged elements, where i varies from 1 to n+1. Each conditional probability P(wᵢtᵢ|w₁t₁ . . . wᵢ₋₁tᵢ₋₁) is approximated as a weighted sum of four terms: in the first three terms, the probability P(wᵢ|tᵢ) of occurrence of element wᵢ given tag tᵢ is multiplied by the probability of occurrence of tag tᵢ, the probability of occurrence of tag tᵢ given preceding tag tᵢ₋₁, and the probability of occurrence of tag tᵢ given preceding tags tᵢ₋₁, and tᵢ₋₂ and the products are weighted by weights λ₁, λ₂, and λ₃, respectively; in the fourth term, the probability of occurrence of tagged element wᵢtᵢ given the preceding tagged element wᵢ₋₁tᵢ₋₁ is weighted by weight λ₄.

When the occurrence probabilities have been calculated as described above, the solution finder 116 selects the hypothesis that gives the highest probability of occurrence of the entire text (step 204 in FIG. 2). This hypothesis can be found by use of the well-known Viterbi algorithm, for example.

If the hypothesis found by the character hypothesis generator 114 includes characters constituting an unknown word, the unknown word restorer 117 reassembles these characters to restore the unknown word (step 205). If the hypothesis found by the character hypothesis generator 114 does not include any characters constituting an unknown word, the unknown word restorer 117 does not operate. The characters constituting an unknown word are reassembled by use of their tags. If the B, I, E, and S tags mentioned above are used, the procedure is as follows. Taking the Japanese character sequence ‘ku/B, ru/I, ma/E, de/S, ma/B, tsu/E’ as an example, in which each syllable represents a hiragana character, the characters from each B-tag to the following E-tag are reassembled to form a word and the single character with the S-tag forms another word, producing the sequence of three unknown words ‘ku-ru-ma/unknown, de/unknown, ma-tsu/unknown’.

Incidentally, the Japanese hiragana character sequence ku-ru-ma-de-ma-tsu is ambiguous in that it can be parsed either as ‘ku-ru-ma de ma-tsu’ (‘wait in the car’) or ‘ku-ru ma-de ma-tsu’ (‘wait until they come’) . This type of ambiguity can be resolved by the use of conventional stochastic models, provided the necessary morphemes are present in the morpheme dictionary so that both candidate hypotheses can be created. In this case, for example, both ‘ku-ru-ma’ and ‘ku-ru’ are necessary; if one or both of these morphemes are missing from the dictionary, conventional analysis may fail. The analysis in the present embodiment succeeds because it can supply the necessary candidate hypotheses by allowing for the possibility that the characters constitute an unknown word.

When the best hypothesis has been found and any unknown words in it have been restored, the output unit 118 outputs the result to the user (step 206).

The n-gram model parameter calculation unit 132 derives n-gram model parameters for use in the approximation formula given in equation (1) above from the part-of-speech tagged corpus stored in the part-of-speech tagged corpus storage unit 131, and stores the parameters in the n-gram model parameter storage unit 122. More specifically, the values P(wᵢ|tᵢ), P(tᵢ), P(tᵢ|tᵢ₋₁), P(tᵢ|tᵢ₋₂tᵢ₋₁), P(wᵢtᵢ|wᵢ₋₁tᵢ₋), λ₁, λ₂, λ₃, and λ₄ are calculated and stored in the n-gram model parameter storage unit 122. The values of P(wᵢ|tᵢ), P(tᵢ), P(tᵢ|tᵢ₋₁), P(tᵢ|tᵢ₋₂tᵢ₋₁), P(wᵢtᵢ|wᵢ₋₁tᵢ₋₁) can be calculated by the maximum likelihood method; the weighting coefficients λ₁, λ₂, λ₃, λ₄ can be calculated by the Expectation Maximization method. These two methods are described on pages 37-41 and 63-66 of ‘kakuritsuteki gengo moderu’ (Stochastic Linquistic Models) by Kenji Kita, published in November 1999 in Japanese by the University of Tokyo Press.

When the n-gram model parameter calculation unit 132 processes unknown words, or words that occur so infrequently that they can be regarded as being nearly unknown, in the part-of-speech tagged corpus stored in the part-of-speech tagged corpus storage unit 131, it divides these words into individual characters and attaches the B, I, E, and S tags described above before calculating the n-gram model parameters and storing the results.

Next the morphological analysis process will be illustrated through an example. First (step 201 in FIG. 2), a user enters a sequence of Japanese kanji and hiragana characters readable as ‘hoso-kawa-mori-hiro-shu-sho-ga-ho-bei’ (‘prime minister Morihiro Hosokawa visits the U.S.A.’), including the unknown word ‘mori-hiro’.

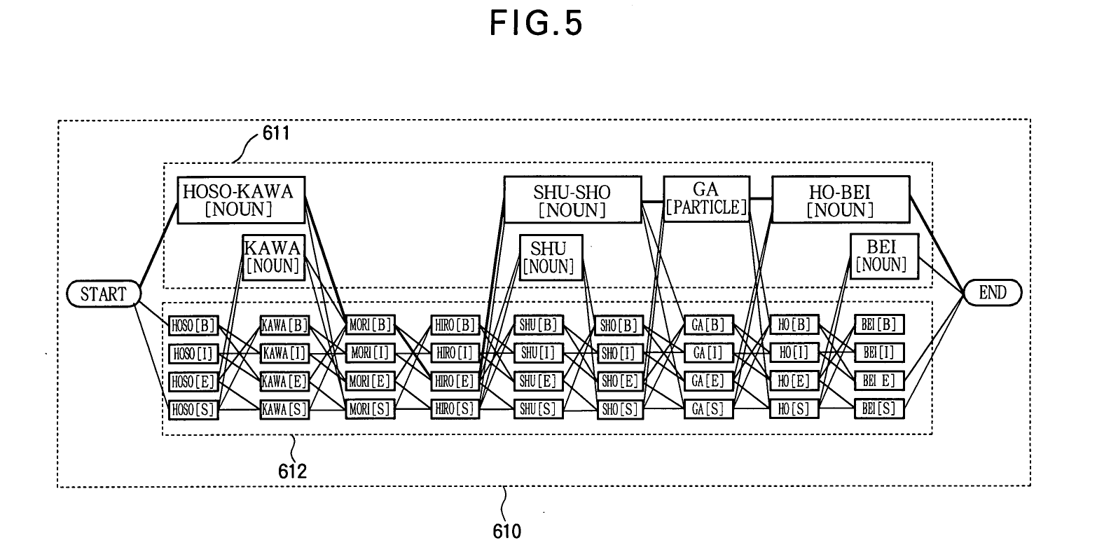

If the morpheme dictionary storage unit 121 stores the dictionary information shown in FIG. 4, the known word hypothesis generator 113 generates hypotheses for the known words as expressed by the upper nodes 611 in the graph FIG. 5, thereby performing the first step 301 in FIG. 3. The character hypothesis generator 114 performs the next step 302 by adding the characters constituting unknown words to the graph as further nodes 612. The hypothesis generator 112 then generates hypotheses represented by the entire graph structure 610 in FIG. 5, thereby performing step 202 in FIG. 2. More specifically, after the known word nodes 611 and unknown word nodes 612 have been generated, the hypothesis generator 112 adds the arcs linking known word nodes 611 to unknown word nodes 612.

It should be noted that no arcs are generated that contradict the positional tags. For example, no arcs are generated linking a B-tagged character in an unknown word to another B-tagged character in an unknown word, an E-tagged character in an unknown word to another E-tagged character in an unknown word, or a B-tagged character in an unknown word to a known word.

The occurrence probability calculator 115 uses equation (1) to calculate the probability of occurrence of each hypothesis (step 203 in FIG. 2). The solution finder 116 finds the hypothesis with the highest probability of occurrence. In FIG. 5, this is the hypothesis indicated by the thick lines. The unknown word restorer 117 reassembles the two tagged characters ‘mori/B’ and ‘hiro/E’ located at unknown word nodes 612 in this hypothesis into the unknown word ‘mori-hiro’, and attaches a tag indicating that the part of speech of the word is unknown. The output unit 118 then outputs the tagged sequence ‘hoso-kawa/noun, mori-hiro/unknown, shu-sho/noun, ga/particle, ho-bei/noun’ as the result of the morphological analysis.

As this example shows, the morphological analyzer 100 in the first embodiment is capable of performing a robust morphological analysis, even when the input text includes unknown words. By dividing an unknown word into its constituent characters, the morphological analyzer 100 can consider arbitrary unknown words that may occur in texts with less computation than conventional systems that process unknown words on a word basis, for while the conventional systems must contend with a substantially unlimited number of possible unknown words, the number of possible constituent characters of these words is limited.

Compared with conventional systems that divide both known words and unknown words into constituent characters, the system of the first embodiment is more accurate because it can make fuller use of information about known words and groups of known words. That is, it analyzes known words with high accuracy by making use of the known information about the words, and analyzes unknown words in a highly robust manner by dividing the words into their constituent characters.

Compared with known methods that rely on the appearance of special types of characters in unknown words, the method of the first embodiment is much more useful because it is applicable to all types of words, regardless of the language or type of characters in which they are entered.

### SECOND EMBODIMENT

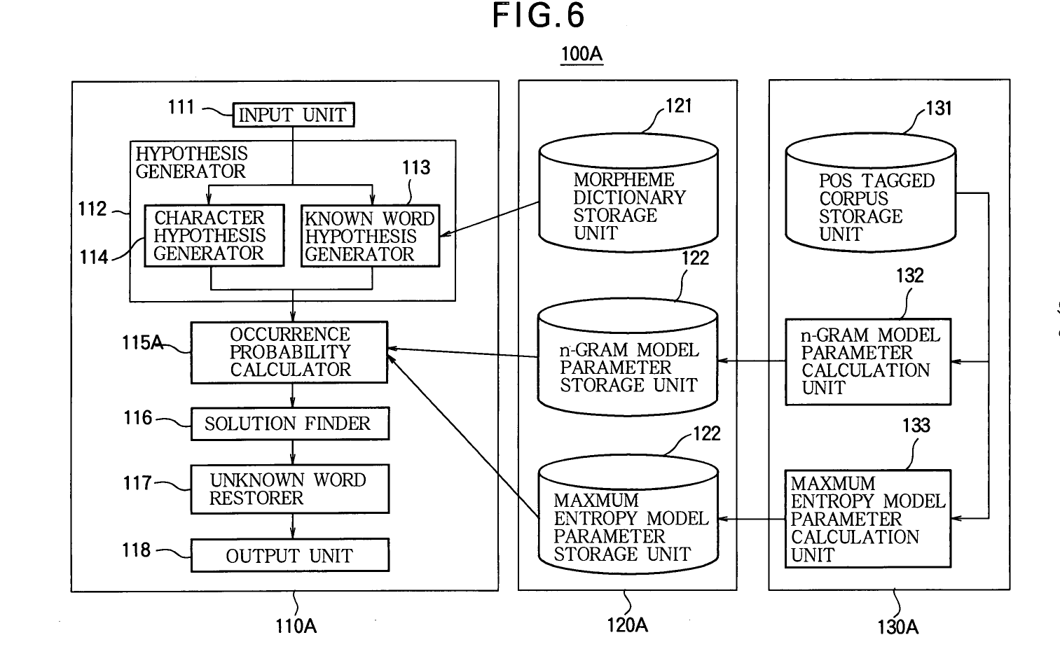

Referring to FIG. 6, the morphological analyzer 100A in the second embodiment adds a maximum entropy model parameter storage unit 123 and a maximum entropy model parameter calculation unit 133 to the structure shown in the first embodiment, and alters the processing performed by the occurrence probability calculator.

The maximum entropy model parameter calculation unit 133 calculates the parameters of a maximum entropy model from the corpus stored in the part-of-speech tagged corpus storage unit 131, and stores the calculated parameters in the maximum entropy model parameter storage unit 123. The occurrence probability calculator 115A calculates occurrence probabilities from both an n-gram model and a maximum entropy model, using both the parameters stored in the n-gram model parameter storage unit 122 and the parameters stored in the maximum entropy model parameter storage unit 123.

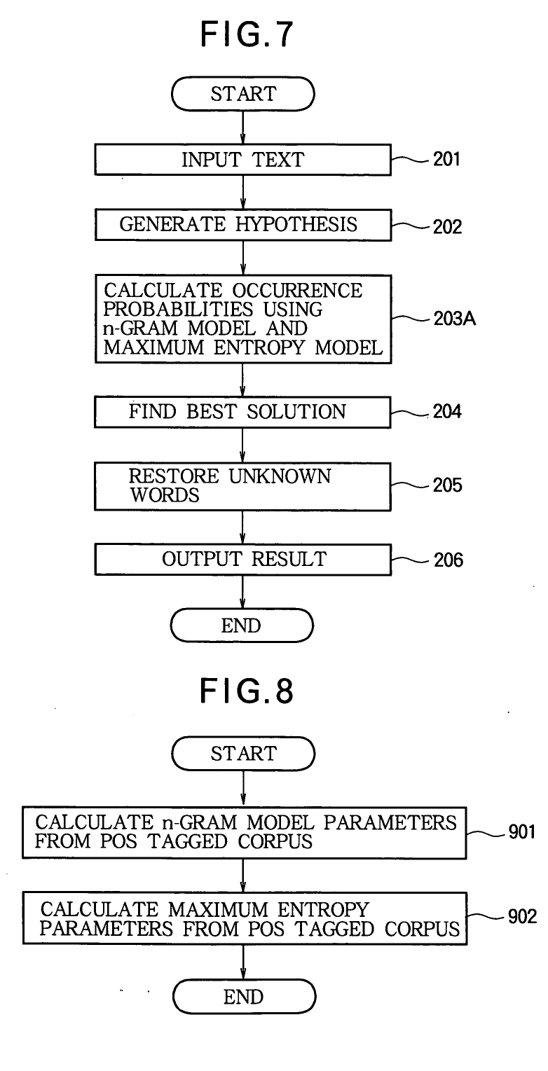

The operation of the morphological analyzer 100A in the second embodiment will be described with reference to the flowchart in FIG. 7. The description will focus on the calculation of occurrence probabilities, since in other regards, the morphological analyzer 100A in the second embodiment operates in the same way as the morphological analyzer in the first embodiment.

After the text to be analyzed has been entered (step 201) and hypotheses have been generated (step 202), the occurrence probability calculator 115A uses the parameters stored in the n-gram model parameter storage unit 122 and maximum entropy model parameter storage unit 123 to calculate occurrence probabilities for the paths (hypotheses) in the graph generated by the hypothesis generator 112 (step 203A).

The occurrence probability calculator 115A in the second embodiment uses the same equation (1) as in the first embodiment, but the conditional probabilities P(wᵢ|tᵢ) of characters tagged with character position tags, indicating that they belong to unknown words, are calculated from equation (2) below. Equation (2) is not used when the i-th node represents a known word.

$$P ( {w}_{i} \vert {t}_{i} ) = \frac{P ( {t}_{i} \vert {w}_{i} ) P ( {w}_{i} )}{P ( {t}_{i} )} \qquad ( 2 )$$

The value of P(tᵢ|wᵢ) on the right side of equation (2) is the probability of occurrence of position tag tᵢ, given that the character it tags is wᵢ. If wᵢ is the i′-th character from the beginning of the text, this probability is calculated according to the maximum entropy method from the following information, in which cₓ is the x-th character from the beginning of the text and yₓ indicates the character type of character cₓ:
(a) characters (c_{i′-2}, c_{i′-1}, c_{i′}, c_{i′+1}, c_{i′+2})
(b) character pairs

(c_{i′-2}c_{i′-1}, c_{i′-1}c_{i′}, c_{i′-1}c_{i′+1}, c_{i′}c_{i′+1}, c_{i′+1}c_{i′+2})
(c) character types (y_{i′-2}, y_{i′-1}, y_{i′, y}_{i′+2})
(d) character type pairs

(y_{i′-2}y_{i′-1}, y_{i′-1}y_{i′}, y_{i′-1}y_{i′+1}, y_{i′y}_{i′+1}, y_{i′+1}y_{i′+2})

Character types may include such types as, for example, alphabetic, numeric, symbolic, and Japanese hiragana and katakana. After the occurrence probabilities have been calculated, the optimal solution is found (step 204), unknown words are restored (step 205), and the result is output (step 206) as in the first embodiment.

The process of calculating the parameters of the n-gram model and the maximum entropy model is carried out in the two steps illustrated in FIG. 8. First, as in the first embodiment, the parameters of the n-gram model are calculated from the part-of-speech tagged corpus (901). This step differs from the first embodiment in that, because equation (2) is used as well as equation (1), the occurrence probability parameters P(wᵢ) must be calculated as well. Next, the maximum entropy model parameter calculation unit 133 calculates the parameters of the maximum entropy model for calculating the probability of occurrence of character position tags conditioned by characters constituting unknown words, and stores the results in the maximum entropy model parameter calculation unit 133 (902). The parameters of the maximum entropy model can be calculated by, for example, the iterated scaling method described on pages 163-165 of the Kenji Kita reference cited above.

The second embodiment provides the same effects as the first embodiment and can be expected to provide the additional effect of greater accuracy in the analysis of unknown words, because of the use of information about character types and notation, including the characters preceding and following each character in an unknown word.

In a variation of the preceding embodiments, hypotheses are generated to include some of the characters in the input text rather than all of the characters. For example, when the input text includes a character sequence that cannot be found in the dictionary in the morpheme dictionary storage unit, the character hypothesis generator may generate hypotheses in which a predetermined number of characters preceding that sequence, a predetermined number of characters following that sequence, and the characters in the sequence, are treated as characters of an unknown word. This variation reduces the number of hypothesis to be considered.

Nodes generated by the known word hypothesis generator and nodes generated by the character hypothesis generator need not be treated alike as they were in the embodiments above: for example, the weighting coefficients applied to probabilities such as P(wᵢ|tᵢ) and P(tᵢ) may differ depending on whether the node in question (wᵢ) was generated by the known word hypothesis generator or the character hypothesis generator.

The set of tags applied the characters constituting unknown words is not limited to the four tags (B, I, E, S) used above. For example, it is possible to use only two tags (B and I) . In this case, the unknown word restorer 117 makes a B-tagged character the first character of a new unknown word, adds each consecutive I-tagged character to the word, and considers that the word has ended when a tag other than an I-tag is encountered. The I-tag is applied not only to intermediate characters in a word, but also to the last character in the word, and the B-tag is also applied to the sole character in a single-character word.

The embodiments above output the most likely hypothesis obtained as the result of the morphological analysis to the user, but the result of the morphological analysis may be output directly to, for example, a machine translation system or other natural language processing system that provides output to the user.

The morphological analyzer need not include the model training facility that was included in the embodiments above; the morphological analyzer may include only the analyzer and model storage facility. The information stored in the model storage facility in this case is generated in advance by a separate model training facility, similar to the model training facility in the embodiments above.

The corpus from which the models are derived may be obtained from a network.

Applications of the invention are not limited to the Japanese language.

Those skilled in the art will recognize that further variations are possible within the scope of the invention, which is defined in the appended claims.

What is claimed is:

1. A morphological analyzer having a dictionary, the morphological analyzer comprising:
a hypothesis generator for receiving a text and generating one or more hypotheses as candidate results of a morphological analysis of the text, the hypotheses including a hypothesis in which known words present in the dictionary are mixed with individual characters constituting an unknown word;
a model storage facility storing information about a stochastic model of morphemes, n-grams, and characters constituting unknown words;
a probability calculator for using the information about the stochastic model stored in the model storage facility to calculate a probability of occurrence of each of the one or more hypotheses;
a solution finder for finding a solution among the one or more hypotheses, based on the probabilities generated by the probability calculator; and
an unknown word restorer for, if the solution found by the solution finder includes an unknown word, reassembling the characters constituting the unknown word to restore the unknown word.

2. The morphological analyzer of claim 1, wherein the model storage facility also stores information about a maximum entropy model.

3. The morphological analyzer of claim 1, wherein the hypothesis generator tags the known words in each hypothesis generated with tags indicating respective parts of speech, and the unknown word restorer tags each restored unknown word with a tag indicating that the word has an unknown part of speech.

4. The morphological analyzer of claim 1, wherein the hypothesis generator tags the individual characters constituting an unknown word with character position tags indicating positions of the individual characters.

5. The morphological analyzer of claim 4, wherein the position tags include a first tag indicating that an individual character is the first character in the unknown word and a second tag indicating that the individual character is another character in the unknown word.

6. The morphological analyzer of claim 4, wherein the position tags include a first tag indicating that an individual character is the first character in the unknown word, a second tag indicating that the individual character is an intermediate character in the unknown word, a third tag indicating that the individual character is the last character in the unknown word, and a fourth flag indicating that the individual character is the sole character in the unknown word.

7. The morphological analyzer of claim 4, wherein the model storage facility also stores information about a maximum entropy model in which a conditional probability of occurrence of a character position tag indicating a position of a character, conditional on the character at the tagged position being a particular character in an unknown word, is derived from information about characters preceding and following the particular character, and about character types of the characters preceding and following the particular character.

8. The morphological analyzer of claim 7, wherein the conditional probability of occurrence of the character position tag is calculated from information about single characters, pairs of characters, single character types, and pairs of character types preceding and following the particular character.

9. A morphological analysis method comprising:
receiving a text;
generating one or more hypotheses as candidate results of a morphological analysis of the text, the hypotheses including a hypothesis in which known words present in the dictionary are mixed with individual characters constituting an unknown word;
calculating a probability of occurrence of each of the one or more hypotheses by using information about a stochastic model of morphemes, n-grams, and characters, the characters constituting unknown words;
finding a solution among the one or more hypotheses, based on the calculated probability of each of the one or more hypotheses; and
reassembling the characters constituting the unknown word to restore the unknown word, if the solution includes an unknown word.

10. The morphological analysis method of claim 9, wherein calculating a probability also includes using information about a maximum entropy model.

11. The morphological analysis method of claim 9, further comprising:
generating one or more hypotheses includes tagging the known words in each hypothesis with tags indicating respective parts of speech; and
reassembling the characters constituting the unknown word includes tagging the restored unknown word with a tag indicating an unknown part of speech.

12. The morphological analysis method of claim 9, wherein generating one or more hypotheses includes tagging the individual characters constituting an unknown word with character position tags indicating positions of the individual characters.

13. The morphological analysis method of claim 12, wherein the position tags include a first tag indicating that an individual character is the first character in the unknown word and a second tag indicating that the individual character is another character in the unknown word.

14. The morphological analysis method of claim 12, wherein the position tags include a first tag indicating that an individual character is the first character in the unknown word, a second tag indicating that the individual character is an intermediate character in the unknown word, a third tag indicating that the individual character is the last character in the unknown word, and a fourth flag indicating that the individual character is the sole character in the unknown word.

15. The morphological analysis method of claim 12, wherein calculating a probability also includes using information about a maximum entropy model in which a conditional probability of occurrence of a character position tag indicating a position of a character, conditional on the character at the tagged position being a particular character in an unknown word, is derived from information about characters preceding and following the particular character, and about character types of the characters preceding and following the particular character.

16. The morphological analysis method of claim 15, wherein the conditional probability of occurrence of the character position tag is calculated from information about single characters, pairs of characters, single character types, and pairs of character types preceding and following the particular character.

17. A machine-readable medium storing a program comprising code executable by a computing device to perform a morphological analysis by the method of claim 9.
